(19) United States
(12) Patent Application Publication
(10) Pub. No.: US 2025/0094839 A1
(43) Pub. Date: Mar. 20, 2025

(54) SYSTEMS AND METHODS FOR APPLYING RULES VIA ARTIFICIAL INTELLIGENCE FOR DOCUMENT PROCESSING

(71) Applicant: The PNC Financial Services Group, Inc., Pittsburgh, PA (US)

(72) Inventors: Simrandeep Singh BAJAJ, McDonald, PA (US); Saima SHAFIQ, Lakeville, MN (US); Prashant NEGINAHAL, Wexford, PA (US); Courtney Marie ZELINSKY, Pittsburgh, PA (US); James Warren MELLOR, JR., Allison Park, PA (US)

(73) Assignee: The PNC Financial Services Group, Inc., Pittsburgh, PA (US)

(21) Appl. No.: 18/968,938

(22) Filed: Dec. 4, 2024

Related U.S. Application Data
(63) Continuation of application No. 18/619,609, filed on Mar. 28, 2024.
Application No. 18/619,609 is a continuation of application No. 18/473,723, filed on Sep. 25, 2023, now abandoned.
(60) Provisional application No. 63/385,746, filed on Dec. 1, 2022.

(51) Int. Cl. G06N 5/022

(52) U.S. Cl. CPC G06N 5/022

(57) ABSTRACT

Computer-implemented systems and methods for applying rules via artificial intelligence for document processing are disclosed. The computer-implemented system comprises a database, a memory storing instructions, and at least one processor configured to receive a plurality of documents from a customer, validate a number and type of the plurality of documents, identify a file type and format of the plurality of documents based on the selection of a plurality of machine learning models, extract and classify a first data set from the plurality of documents based on the selection of the plurality of machine learning models using the identification of the file type and the format, reconstruct the first data set into a structured data set, transform the structured data set into a customized new presentation, receive a change from a user, optimize the selection of the plurality of machine learning models, and display the modified customized new presentation.

### CROSS-REFERENCE TO RELATED APPLICATION

This application claims priority to U.S. Provisional Patent Application No. 63/385,746, filed on Dec. 1, 2022, is the entire contents of which are incorporated herein by reference.

### TECHNICAL FIELD

The present disclosure generally relates to computerized systems and methods for applying rules via artificial intelligence for document processing. In particular, embodiments of the present disclosure relate to inventive and unconventional systems and methods for automatic and intelligent processing of any business' documents with artificial intelligence.

### BACKGROUND

Forms or documents of various types are widely used for collecting information for various purposes. Medical, commercial, educational and governmental organizations use documents of various formats for collecting information and for record keeping purposes. The advent of computers and communication networks resulted in the documents being moved online so that people no longer have to fill out forms on paper. In addition, digitized records, including electronic and scanned copies of paper documents, are now generated using computers. These electronic documents are shared over the communication networks thereby saving time and resources that may be otherwise required for generating and exchanging paper documents.

These documents may contain data in structured and unstructured formats. A structured document may have embedded code which may enable arranging the information in a specified layout, arrangement or other format. Unstructured documents may include free form arrangements, wherein the structure, style and content of information in the original documents may not be preserved. It is not uncommon for record-keeping entities to create and store large unstructured electronic documents that may include content from multiple sources.

Often, various enterprise systems wish to utilize information from electronic documents to perform operations. It is relatively easy to programmatically extract information from structured documents that have a well-defined or organized data model, such as extracting data from fields in a form where the fields are at a known location in the form (e.g., data in a tabular arrangement). However, when the electronic documents include large unstructured documents, it is technically difficult to extract information that may be needed to perform operations of enterprise systems or other types of systems. Unstructured documents often do not have well-defined data models, making it difficult to reliably programmatically parse and extract the needed information from the documents.

In addition, current intelligent document processing platforms may be limited in their ability to process various document types where users may be forced to rely on a variety of platforms to tailor their needs according to the functionality and capabilities of those intelligent document processing platforms using only a single machine learning model. Furthermore, current intelligent document processing platforms may be limited in that the machine learning model may be incapable of learning from feedback of human reviewers when certain document types, or the number of documents, are not supported by the machine learning model.

Therefore, there is a need for improved methods and systems for intelligent document processing using artificial intelligence that may rely on a plurality of machine learning models and/or algorithms. The artificial intelligence system using a plurality of machine learning models and/or algorithms for processing documents may ingest any unstructured document using multiple machine learning models for different use cases where the output of the transformed structured data may be tailored for different business requirements. The artificial intelligence system using a plurality of machine learning models and/or algorithms for processing documents may provide various process flows for classifying and extracting data from a plurality of documents. The artificial intelligence system using a plurality of machine learning models and/or algorithms for processing documents may integrate a set of data into desired document formats based on feedback provided by a human reviewer whereby the artificial intelligence system may learn and adapt to the changes provided by the human reviewer.

### SUMMARY

One aspect of the present disclosure is directed to a computer-implemented system for applying rules via artificial intelligence for document processing. The computer-implemented system comprises a database, a memory storing instructions, and at least one processor. The at least one processor may be configured to execute the instructions to receive a plurality of documents from a customer via a first user interface, validate a number and a type of the plurality of documents, and identify a file type and a format of the plurality of documents based on a selection of a plurality of machine learning models using the validation of the number and the type of the plurality of documents. The at least one processor may be configured to further execute the instructions to extract and classify a first data set from the plurality of documents based on the plurality of machine learning models using the identification of the file type and the format of the plurality of documents, reconstruct the first data set into a structured data set based on the plurality of machine learning models using the extraction and classification of the first data set, transform the structured data set into a customized new presentation of the structured data set, receive a change from a user via a second user interface to modify the customized new presentation, optimize the plurality of machine learning models based on the change from the user, and display to the customer via the first user interface the modified customized new presentation and the plurality of documents for comparison.

Another aspect of the present disclosure is directed to a method for applying rules via artificial intelligence for document processing. The method may comprise the steps of receiving a plurality of documents from a customer via a first user interface, validating a number and a type of the plurality of documents, identifying a file type and a format of the plurality of documents based on a selection of a plurality of machine learning models using the validation of the number and the type of the plurality of documents, extracting and classifying a first data set from the plurality of documents based on the plurality of machine learning models using the identification of the file type and the format of the plurality of documents, reconstructing the first data set into a structured data set based on the plurality of machine learning models using the extraction and classification of the first data set, transforming the structured data set into a customized new presentation of the structured data set, receiving a change from a user via a second user interface to modify the customized new presentation, optimizing the plurality of machine learning models based on the change from the user, and displaying to the customer via the first user interface the modified customized new presentation and the plurality of documents for comparison.

Yet another aspect of the present disclosure is directed to a computer-implemented system for applying rules via artificial intelligence for document processing. The computer-implemented system comprises a database, a memory storing instructions, and at least one processor. The at least one processor may be configured to execute the instructions to receive a plurality of documents from a customer via a first user interface, validate a number and a type of the plurality of documents, and identify a file type and a format of the plurality of documents based on a master machine learning model using the validation of the number and the type of the plurality of documents. The at least one processor may be configured to further execute the instructions to extract and classify a first data set from the plurality of documents based on the master machine learning model using the identification of the file type and the format of the plurality of documents, reconstruct the first data set into a structured data set based on the master machine learning model using the extraction and classification of the first data set, transform the structured data set into a customized new presentation of the structured data set, receive a change from a user via a second user interface to modify the customized new presentation, optimize the master machine learning model based on the change from the user, and display to the customer via the first user interface the modified customized new presentation and the plurality of documents for comparison.

Other systems, methods, and computer-readable media are also discussed herein.

### BRIEF DESCRIPTION OF THE DRAWINGS

FIGS. 1A and 1B are schematic block diagrams illustrating an exemplary embodiment of the artificial intelligence platform for processing documents, consistent with the disclosed embodiments.

FIG. 2 is a schematic block diagram illustrating an exemplary embodiment of the artificial intelligence platform using a plurality of third-party machine learning models and/or algorithms locally and/or in the cloud, consistent with the disclosed embodiments.

FIGS. 3A-B schematically depict exemplary process flows of a plurality of documents, consistent with disclosed embodiments.

FIG. 4 depicts an exemplary illustration of extracting and classifying data contained in a document into a structured data output, consistent with the disclosed embodiments.

FIG. 5 depicts an exemplary human review user interface for manipulating transformed structured data into a new presentation of data from a desired form, consistent with the disclosed embodiments.

FIG. 6 depicts an exemplary process for model retraining based on corrections from a human review user interface, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to apply rules via artificial intelligence for document processing where the systems and methods may leverage the use of a plurality of machine learning algorithms or models to accurately reconstruct or transform a plurality of documents containing unstructured data, semi-structured data, and/or structured data in various forms into one or more structured data forms. In another embodiment, the present disclosure is directed to systems and methods configured to provide a library of a plurality of machine learning models to process data and/or information contained in a plurality of documents related to a variety of financial service organizations to accurately reconstruct or transform the data and/or information in the plurality of documents containing unstructured data, semi-structured data, and/or structured data into a single accessible portal for use by businesses and technical users. Unstructured data may include information contained in one or more forms, such as files or documents that may not have any meta data associated with the data or may not have been organized, grouped, and/or summarized into a structured data format such as JavaScript object notation (JSON) structured data. Files or documents may include, for example, word files, excel spreadsheet files, PowerPoint presentation files, pdf files, and/or picture files (png, jpeg, bmp, and/or tiff, gif, or any other related file extensions) and/or other types of data and/or information. Structured data may include the assimilation and/or combination of a plurality of unstructured data into one or more forms of structured data such that the information contained in the structured data may be used to, e.g., make decisions or infer a trend. The structured data may be presented to one or more customers in a format tailored according to the one or more customer's needs. Semi-structured data may include information in both an unstructured data form and structured data form. Artificial intelligence systems may be used in this system to convert the plurality of documents from unstructured data, semi-structured data, and/or structured data into a structured data format. Furthermore, artificial intelligence systems may be used to transform the structured data into a new representation or presentation of data according to one or more customer needs.

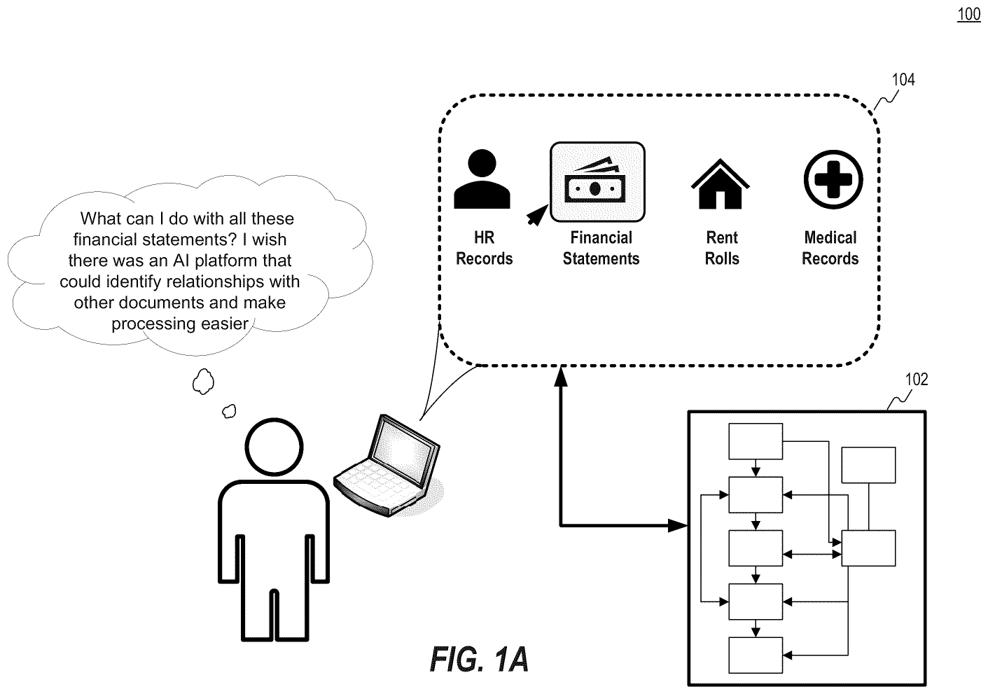

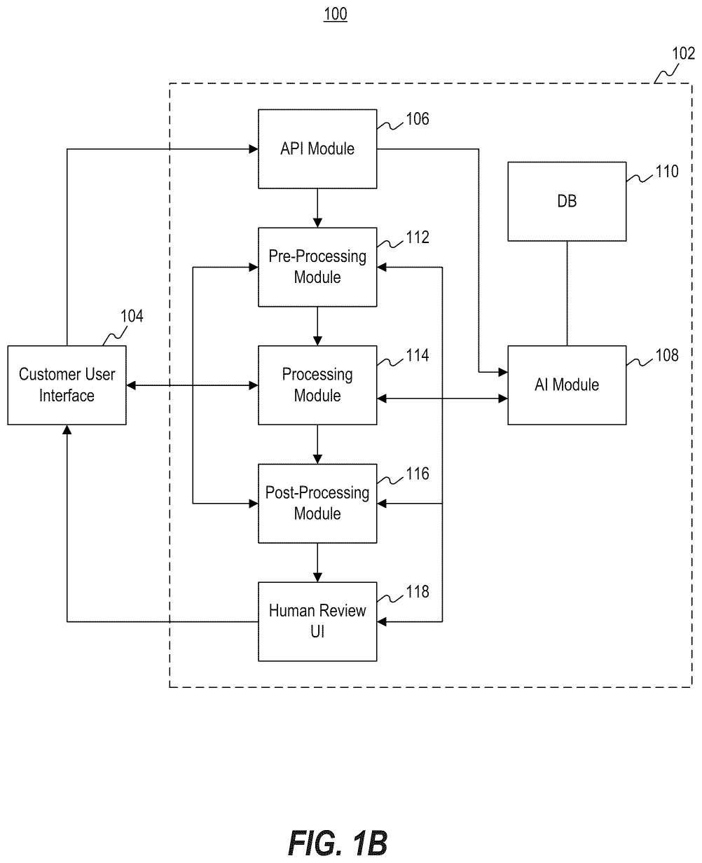

FIGS. 1A-B depict schematic block diagrams illustrating an exemplary embodiment of the artificial intelligence system 100 for processing documents, consistent with the disclosed embodiments. System 100 may be employed as part of a Document AI platform such as, e.g., a digital experience platform (DXP). In one embodiment, system 100 may process data and/or information contained in a plurality of documents for one or more different business organizations or groups (e.g., a variety of financial service organizations). The plurality of documents for the one or more different business organizations or groups may include retail business documents, asset management documents, treasury management documents, commercial lending documents, corporate lending documents, health care documents, corporate financial documents, business transaction documents, invoices, receipts, and/or any other documents containing data. Processing data may mean the act of reading, extracting, verifying, classifying, validating, writing, restructuring, rearranging and/or structuring data contained in a plurality of documents with various formats and file extensions—e.g., .docx file extensions, .pdf extensions, and/or .xlsx extensions, or any other related file extensions—to transform the data contained in the plurality of documents for representation or display of the transformed data in a new medium or file format. Processing data may also mean that the unstructured data, the semi-structured data, and/or the structured data contained in the plurality of documents may be reduced to a smaller representation or display of the transformed structured data in a new medium or file format to include only important information requested by one or more users and/or customers. The new medium or file format may be an interactive webpage, a graphical user interface display, a pdf file, a presentation file, an excel file, and/or any other interactive medium or file formats.

In another embodiment, system 100 may process the data contained in the plurality of documents to transform the data into a new presentation of data or display of data—new medium and/or file format—that may be tailored to a customer's requirements and/or needs. For example, system 100 may process data in retail business documents, asset management documents, treasury management documents, commercial lending documents, corporate lending documents, corporate financial documents, business transaction documents, invoices, and/or receipts for transformation into one or more health care related business documents, or any other related business documents. In another example, system 100 may process data for treasury management documents for transformation into retail business documents, asset management documents, commercial lending documents, corporate lending documents, corporate financial documents, business transaction documents, invoices, and/or receipts. The new presentation of data or display of data may be in the form of pdf files, word document files, spreadsheet files, PowerPoint slide files, graphical user interfaces (GUI), webpage interface, mobile application, picture files, and/or any other file format for displaying and/or presenting data—new medium and/or file format.

System 100 may utilize artificial intelligence to process data from the plurality of documents where the artificial intelligence may use one or more machine learning models and/or algorithms where the one or more machine learning models and/or algorithms may be local to its system or may include third-party machine learning models and/or algorithms in one or more cloud environments separate from the local system where the third-party machine learning models and/or algorithms may be located at a different entity or business cloud environments. The artificial intelligence in system 100 may optimize and/or leverage the usage of the one or more machine learning models and/or algorithms to process the data in the plurality of documents to meet a customer's request for an output of transformed data.

In one embodiment, system 100 may have a central artificial intelligence that may learn from the one or more machine learning models and/or algorithms' transformed data outputs and the customer feedback or inputs to adjust the output of the transformed data to better meet customers' requirements. In another embodiment, system 100 may have a central artificial intelligence that may learn from customer feedback or inputs to adjust the output of the transformed data to better meet customers' requirements. In yet another embodiment, system 100 may have a human reviewer and/or a human quality control reviewer to review the output of the transformed data against a customer's requirements and/or compare a document containing data against the output of the transformed data. System 100's artificial intelligence may use the input from the human reviewer to learn or verify which machine learning models and/or algorithms are best suited for a certain type of plurality of documents for different one or more business organizations or groups. In another embodiment, system 100 may initially receive supervised learning techniques where a human reviewer and/or a human quality control reviewer may assign a variety of sample documents (from different one or more business organizations or groups) to system 100 in order to train system 100 to recognize data contained in the variety of sample documents. The human reviewer and/or human quality control reviewer may annotate and/or tag various specific data and/or information in the variety of sample documents to teach, train, or retrain system 100 to recognize data and/or information processed in a future plurality of documents requested by customers.

As seen in FIG. 1A, system 100 may include intelligent document processor 102 (referred to herein as IDP 102) and customer user interface 104 (referred to herein as customer UI 104). Customer UI 104 may be available simultaneously to one or more customers (referred to herein as customer) through a webpage, a server environment, a cloud environment, a mobile application, a software, and/or any other user interfaces. Customer UI 104 may comprise a first user interface through which a plurality of documents may be received into IDP 102. IDP 102 may comprise one or more processors configured to execute the various machine learning, classification and other document processing functions disclosed herein.

A user may access customer UI 104 via, e.g., a web-enabled device such as a personal computer. Customer UI 104 may interact with IDP 102 to communicate selections from the user, download unprocessed documents from a user, upload processed documents to a user, and generally enable a user to engage with IDP 102. Customer UI 104 may provide a user with a user-friendly menu for selecting model extraction and other processing services for documents such as, e.g., human resources records, financial statements, rent rolls, medical records, tax forms, ACORD forms, invoices, death certificates, Master Resolution and Authorization documents, Deposit Account Control Agreements, etc. Alternatively or additionally to document type, customer UI 104 may provide a menu of model extraction and document processing services based on another class of categories such as, e.g., file format type. A customer may make a selection command via the customer UI 104 to select the desired document processing services. Alternatively or additionally to a visual menu, customer UI 104 may comprise, e.g., a text field for receiving a free-form text description from a user. The user may then enter a free-form description of its particular document processing needs. An AI-based natural language processing algorithm may process the free-form text description as the selection command, or it may utilize the free-form text description to, e.g., hone in on the user's needs and narrow the number of available menu selections.

Based on the selection command, IDP 102 may select a plurality of machine learning models from the catalog of pre-trained machine learning model combinations. IDP 102 may receive a plurality of documents from the user, such as via customer user interface 104 or another transmission service, and process the plurality of documents as discussed above using the selected plurality of pre-trained machine learning models. Although the plurality of machine learning models may be initially pre-trained according to an expected use case, they may be further trained and re-trained for the specific plurality of documents as discussed above using, e.g., human reviewers such as annotators and/or operational users. Alternatively, system 100 may comprise a sandbox feature. The sandbox feature may comprise an isolated practice environment in which a user may experiment with various processing services using sample documents provided by system 100, without affecting the system or the user's own documents.

Alternatively or in addition to selecting from the catalog of pre-trained machine learning model combinations based on a selection command, IDP 102 may select from the catalog of pre-trained machine learning model combinations based on a determination of best fit for processing the plurality of documents received. For example, IDP 102 may be configured to identify the most suitable machine learning model and/or algorithms based on, e.g., a file type, document type, industry class, or customer request information. In some embodiments, best fit may be determined based on, e.g., a plurality of test runs of a selected sample of documents through different machine learning models and/or algorithms. In some embodiments, best fit may be determined based on historical information, such as by comparing the plurality of documents to information from prior document processing operations. For example, IDP 102 may be configured to compare characteristics of the present plurality of documents to characteristics of previously received documents to determine whether any processes applied to the previously received documents would be suitable for the present plurality of documents. Therefore, in some embodiments, the user itself need not select from a menu, but may upload the plurality of documents and allow IDP 102 to make the selection. Furthermore, alternatively or in addition to full service document processing, document AI platform 100 may offer a la carte access to any of pre-processing, processing, and post-processing services as further discussed below via customer UI 104.

As seen in FIG. 1B, IDP 102 may include application programming interface module 106 (referred to herein as API module 106), artificial intelligence module 108 (referred herein as AI module 108), one or more databases 110 (referred to herein as DB 110), pre-processing module 112 (referred to herein as PrePM 112), processing module 114 (referred to as PM 114), post-processing module 116 (referred to herein as PostPM 116), and human review user interface 118 (referred to as HRUI 118). System 100 may include a memory storing instructions and at least one processor to execute the instructions in IDP 102.

API module 106 may collect information from a plurality of documents submitted by a customer via customer UI 104. The collection of information by API module 106 may include validating the number of the plurality of documents submitted by the customer where API module 106 may keep track of each request coming from the customer. For example, validating the number of documents may comprise determining the number of distinct documents contained within the information collected by API module 106. In another embodiment, the collection of information by API module 106 my include obtaining, validating, and/or verifying the type of plurality of documents submitted by the customer in customer UI 104, and API module 106 may associate the type of the plurality of documents submitted by the customer with the plurality of documents. For example, validating and/or verifying may comprise the steps of verifying the information or values in a number of fields such as, e.g., a file type, file name, hash value, login, client application, etc. The type of the plurality of documents may be an identification of an organization and/or group that the plurality of documents may come from.

In yet another embodiment, API module 106 may collect a customer request as information, such as by obtaining the type of transformation of data for new presentation of data or display of data that the customer has requested via customer UI 104. For example, a customer may request that health care business documents be transformed into corporate financial documents and/or any other plurality of documents for different one or more business organizations or groups. Health care business documents may comprise, e.g., a plurality of asset management documents from an asset management group. The asset management documents may comprise information about, e.g., values of medical equipment, office equipment, inventory, buildings, and other property. The requested transformation may comprise, e.g., identifying, extracting, transforming, combining or converting this value information into corporate lending documents, such collateral statements for securing corporate loans. API module 106 may collect this request as part of the collection of information.

In yet another embodiment, API module 106 may check that system 100 may read or write the plurality of documents, for example, by analyzing permission attributes of the document files. The collected information in API module 106 may include the validation and number of the plurality of documents, the type of plurality of documents, the type of transformation of data for new presentation of data or display of data requested from customer, and the information related to the readability or writability of the plurality of documents. The validation of the plurality of documents may refer to determining whether system 100 is able to read and/or write into the plurality of documents and/or obtain information such as the file extension, the number of pages of a document, and/or the sizes, colors, formats, pictures, tables contained in a document, and/or any other related document information.

API module 106 may send the collection of information to AI module 108. AI module 108 may save the collection information into DB 110. AI module 108 may determine the type of machine learning models and/or algorithms to use for different tasks in IDP 102 based on the collection of information provided by API module 106. Thus, AI module 108 may be configured to select a plurality of machine learning models based on the plurality of documents received at customer UI 104. For example, AI module 108 may comprise a plurality of machine learning models and/or algorithms that have been trained to specific processing tasks based on, e.g., the file type (such as .docx, pdf, .xls., .png, etc.), the industry (such as, e.g., health care, human resources, finance, etc.), and/or specific document types (such as, e.g., financial statements, invoices, etc.) AI module 108 may comprise one or more classification algorithms configured to direct files from the collected information to an appropriate trained machine learning model and/or algorithm based on, e.g., the above characteristics. In one embodiment, AI module 108 may control IDP 102. In yet another embodiment, AI module 108 may control API module 106, DB 110, PrePM 112, PM 114, and PostPM 116.

AI module 108 may obtain feedback from HRUI 118. For example, feedback may comprise a plurality of human-reviewed documents. The plurality of human-reviewed documents may comprise, e.g., corrections to documents that were previously processed in, e.g., PrePM 112, PM 114, PostPM 116, or AI module 108. Alternatively, the plurality of human-reviewed documents may comprise documents that were processed by a human reviewer while the same documents were also processed in parallel by one or more of the modules of IDP 102 discussed above. The documents processed by IDP 102 may comprise a first set of outputs for a given set of inputs, while the feedback, such as the human-reviewed documents or corrections, may comprise a second set of outputs for the given set of inputs. AI module 108 may compare the first and second sets of outputs as further training data to further train the one or more machine learning models and/or algorithms. For example, AI module 108 mayretrieve the collected information from API module 106 saved in DB 110 to compare the feedback received from HRUI 118 against the collected information. AI module 108 may learn from the feedback to later adjust its machine learning models and/or algorithms, such as by further training the machine learning models and/or algorithms, or optimize the selection of certain types of machine learning models and/or algorithms.

AI module 108 may select machine learning models and/or algorithms to pre-process the plurality of documents via PrePM 112 where AI module 108 may store the information collected in PrePM 112 into DB 110. In one embodiment, AI module 108 may separately select a plurality of machine learning models and/or algorithms simultaneously to pre-process the plurality of documents via PrePM 112 where the AI module 108 may store information collected in PrePM 112 into DB 110.

PrePM 112 may identify the file type and/or file extension in the plurality of documents where the file types may be word files (with .doc, .docx, .docm, and/or dotm extensions), text files (with .dat, .txt, and/or .rtf file extensions), spreadsheet files (with .xls, .xlsx, and/or .xlsm file extensions), pdf files, and/or picture files (.jpeg, .png, .tiff, .bmp, .gif, .psd, and/or .raw file extensions). In another embodiment, the file type may also include the type of documents related to retail business documents, asset management documents, treasury management documents, commercial lending documents, corporate lending documents, health care documents, corporate financial documents, business transaction documents, invoices, receipts, and/or any other documents containing data. The file type information collected by PrePM 112 may be stored in DB 110 by AI Module 108. PrePM 112 may also use the optical character recognition (OCR) available in AI module 108's machine learning models and/or algorithms to collect information about the layout, arrangement or other format of the plurality of documents. In another embodiment, PrePM 112 may convert one file type to another when AI module 108 may determine that it may be unable to obtain format information from the plurality of documents. In another embodiment, PrePM 112 may convert all file types to a specific pdf extension file to enable OCR functionality for further processing in IDP 102. The collected information about the original format of the plurality of documents may be stored in DB 110 by AI module 108. Furthermore, the AI module 108 may store the information related to the conversion of documents from one file type to another in DB 110. PrePM 112 may further use rule-based splitting in AI module 108's machine learning models and/or algorithms to split files into multiple documents. For example, a document such as a business financial statement may include the businesses balance sheet, income statement, cash flow statement, statement of changes in shareholder equity, and statement of comprehensive income. AI module 108 may use rules to identify the type of content in the business financial statement to independently determine to split this business financial statement into six different files being a balance sheet file, an income statement file, cash flow statement file, statement of changes in shareholder equity file, and statement of comprehensive income file. The splitting of the document into multiple files may allow AI module 108 to efficiently categorize the unstructured data, the semi-structured data, and/or the structured data in those files for efficient processing of the required information for presentation to a user. For example, AI module 108 may use rule-based splitting based on the collected information from API module 106 and PrePM 112 stored in DB 110 to decide whether to split documents into additional documents. Rule-based splitting may comprise, e.g., using a set of predefined or learned rules that relate a characteristic of a document (such as specific textual terms, header information, metadata, a format of structured data, the presence of image data or signature fields, etc.) with a particular classification. For example, if collected information comprises three distinct classes of financial documents, such as signature cards, W8 forms and customer due diligence (CDD) documentation, rule-based splitting may be used to identify and assign each type document to its proper class. Rule-based splitting may allow AI module 108 to further segregate data contained in the plurality of documents for later classification and data extraction by machine learning models and/or algorithms that are trained specifically for processing tasks associated with that class of documents. The collected information in PrePM 112 may be the file type information, the format of the plurality of documents, the plurality of documents that were converted from one file type to another, and whether rule-based splitting was used to split documents. AI module 108 may save the collected information in DB 110. In another example, a document may be saved as an excel file, and PrePM 112 may convert the document to a pdf file for further processing in IPD 102.

AI module 108 may obtain feedback from HRUI 118 and retrieve the collected information from PrePM 112 or the combination of API module 106 and/or PrePM 112 saved in DB 110 to compare the feedback received from HRUI 118 against the collected information from PrePM 112 or the combination of API module 106 and/or PrePM 112. AI module 108 may learn from the feedback as discussed above to later adjust its machine learning models and/or algorithms or optimize the selection of certain types of machine learning models and/or algorithms.

PM 114 may process the unstructured data, the semi-structured data, and/or the structured data contained in the plurality of documents by extracting via OCR and classifying the data with the use of the AI module 108's machine learning models and/or algorithms. For example, PM 114 may be configured to extract a first data set from the plurality of documents based on, e.g., a plurality of machine learning models using the identification of the file type and the format of the plurality of documents. PM 114 may further be configured to classify the first data set based on the plurality of machine learning models using the identification of the file type and the format of the plurality of documents. In some embodiments, the AI module 108 may select a single machine learning model and/or algorithm to perform the data extraction and classification based on information saved in DB 110 from API module 106 and/or PrePM 112. For example, data extraction may comprise an operation for identifying or recognizing data, such as recognizing text or image data using OCR or image recognition models and/or algorithms. Classification may comprise sorting the extracted information into predetermined or learned categories. In another embodiment, AI module 108 may simultaneously extract and classify the unstructured data, the semi-structured data, and/or the structured data contained in the plurality of documents with machine learning models and/or algorithms where AI module 108 may save a plurality of the unstructured data, the semi-structured data, and/or the structured data extracted and classified in DB 110. AI module 108 may construct a table reporting the accuracy, precision, and confidence level of the extracted and classified data processed in PM 114 for each machine learning model and/or algorithm used for PM 114. For example, accuracy may refer to the proportion of a set of data values that are correctly extracted or identified. Precision may characterize the consistency of an extraction of classification operation, such as how closely a set a of similar extractions match each other. A confidence level may represent a probability that an extracted or classified value or class of values is correct. The table reporting the accuracy, precision, and confidence level associated with each of the machine learning models and/or algorithms may allow AI module 108 to learn about the strengths and weaknesses of each of the machine learning models and/or algorithms. The extracted and classified unstructured data, the semi-structured data, and/or the structured data and the table reporting the accuracy, precision, and confidence level of each of the machine learning models and/or algorithms may be saved in DB 110 by AI module 108. The collected information in PM 114 may be the extracted and classified unstructured data, the semi-structured data, and/or the structured data from the plurality of documents and tables reporting the accuracy, precision, and confidence level of each machine learning models and/or algorithms. AI module 108 may save the collected information in DB 110.

AI module 108 may obtain feedback from HRUI 118 and retrieve the collected information from PM 114 or the combination of API module 106, PrePM 112, and/or PM 114 saved in DB 110 to compare the feedback received from HRUI 118 against the collected information from PM 114 or the combination of API module 106, PrePM 112, and/or PM 114. AI module 108 may learn from the feedback to later adjust its machine learning models and/or algorithms or optimize the selection of certain types of machine learning models and/or algorithms.

PostPM 116 may construct structured data from the unstructured data, the semi-structured data, and/or the structured data of the plurality of documents where AI module 108 may use machine learning models and/or algorithms to modify, reconstruct, standardize, and/or customize the data and/or formatting of the unstructured data, the semi-structured data, and/or the structured data. For example, PostPM 116 may be configured to reconstruct the first data set into a structured data set based on the plurality of machine learning models using the extraction and classification of the first data set. The structured data may be a tabular structure of the data extracted and classified in PM 114 based on AI module 108 retrieving collected information from API module 106, PrePM 112, and/or PM 114. AI module 108 may simultaneously create a plurality of sets of structured data based on the machine learning models and/or algorithms, each set of structured data comprising a different iteration of the machine learning models and/or algorithms. The outputs from each iteration may be assessed and compared against each other using, e.g., data contained in tables reporting the accuracy, precision, and confidence level of the structured data metric report to select an optimal output set or to further train the machine learning models and/or algorithms.

AI module 108 may transform the structured data into a customized new presentation of data or display of data being in the form of pdf files, word document files, spreadsheet files, PowerPoint slide files, graphical user interfaces (GUI), webpage interface, mobile application, picture files, and/or any other file format—new medium and/or file format—based on customer request for outputs of transformed data. A customized new presentation may comprise, e.g., a change to the format, arrangement, data structure, or data values of the structured data. In some embodiments, AI module 108 may transform a plurality of structured data into a plurality of customized new presentation of data or display of data. The information collected in PostPM 116 may include the structured data, the metric report in creating structured data containing comparisons with other machine learning models and/or algorithms, and the transformed structured data into one or plurality customized new presentation of data or display of data. AI module 108 may save the collected information in DB 110.

AI module 108 may obtain feedback from HRUI 118 and retrieve the collected information from PostPM 116 or the combination of API module 106, PrePM 112, PM 114, and/or PostPM 116 saved in DB 110 to compare the feedback received from HRUI 118 against the collected information from PM 114 or the combination of API module 106, PrePM 112, and/or PM 114. HRUI 118 may comprise a second user interface, and the feedback may comprise an input to the second user interface. Therefore IDP 102 may be configured to receive an input from a user via a second user interface to modify the customized new presentation. AI module 108 may learn from the feedback to later adjust its machine learning models and/or algorithms or optimize the selection of certain types of machine learning models and/or algorithms to optimize the customized new presentation of data or display of data. Then IDP 102 may be configured to modify the customized new presentation based on the adjusted plurality of machine learning models.

AI module 108 may send the customized new presentation of data or display of data to a customer via customer UI 104. For example, the customer may download one or more files of the customized new presentation of data, or it may be displayed on a screen via customer UI 104. In another embodiment, AI module 108 may send the new presentation of data or display of data to one or more human reviewers or quality control reviewers (referred to herein as human reviewer) via HRUI 118. HRUI 108 may allow human reviewer to upload a different format of the new presentation of data or display of data to AI module 108 or DB 110. The different format may be based, e.g., on the customer request as interpreted by the human reviewer. AI module 108 may thus learn of a proper format based on a customer request for output of transformed data based on input from HRUI 108. In some embodiments, HRUI 108 may allow human reviewer to select one or more values of data in one or more customized new presentations of data or display of data, and AI module 108 may retrieve the original collected information from API module 106, PrePM 112, PM 114, and/or PostPM 116 associated with the selected one or more values of data. Human reviewer may compare the selected one or more values of data in one or more customized new presentations of data or displays of data with the original collected information from API module 106, PrePM 112, PM 114, and/or PostPM 116, and human reviewer may change the values of the selected one or more values of data based on the comparison. AI module 108 may update the one or more customized new presentations of data or displays of data based on the changes provided by human reviewer in HRUI 118. AI module 108 may collect information that may include uploaded formats or changes in values of one or more selected values of data in one or more customized new presentations by human reviewer in HRUI 118.

In another embodiment, AI module 108 may propose changes to formats and/or one or more values of data selected by human reviewer based on the simultaneous creating of the plurality of customized new presentations of data or displays of data in PostPM 116. For example, AI module 108 may propose changes to the formats and/or values based on predefined templates for a certain class of documents to be processed. Alternatively, AI module 108 may anticipate an output based on information learned in a prior similar document processing operation, and may propose changes based on the anticipated output. AI module 108 may collect information that may also include the proposed formats and/or one or more values of data selected by human reviewer. AI module 108 may save the collected information in DB 110. AI module 108 may continually learn and train itself by compiling and comparing information, including: the collected information, the unstructured data, the semi-structured data, the structured data, and the metric report in creating structured data, the plurality of customized new presentation of data or display of data, and the changes requested by human reviewer. By compiling and comparing the information, AI module 108 may identify patterns to teach itself to anticipate an output based on one or more requests from customers or users.

AI module 108 may obtain feedback from HRUI 118 and retrieve the collected information from HRUI 118 or the combination of API module 106, PrePM 112, PM 114, PostPM 116, and/or HRUI 118 saved in DB 110 to compare the feedback received from HRUI 118 against the collected information from PM 114 or the combination of API module 106, PrePM 112, PM 114, PostPM 116, and/or HRUI 118. AI module 108 may learn from the feedback to later validate or adjust its machine learning models and/or algorithms or optimize the selection of certain types of machine learning models and/or algorithms to optimize the customized new presentation of data or display of data from a sample of a plurality of documents. In another embodiment, the human reviewer may be an annotator and/or an operational user. For example, a human reviewer may be considered an annotator if, e.g., the human reviewer leverages its understanding of intelligent document processing to teach, train, and/or retrain AI module 108. The annotator may input a variety of sample documents that may contain annotations or tags about specific data and/or information from various one or more business organizations or groups to help AI module 108 recognize the specific data and/or information contained in the annotations or tags. For example, the annotator may annotate “current assets” in a balance sheet to initially teach, train, and/or retrain AI module 108 to recognize current assets in any other balance sheets. A human reviewer may be considered an operational userif, e.g., the human reviewer leverages its subject matter expertise in one or more business organizations or groups relevant to the particular documents being processed. The operational user may apply their understanding of the subject matter to provide feedback to AI module 108.

AI module 108 may directly provide PrePM 112 collected information to customer in customer UI 104 because that may be the only information sought by a customer. In another embodiment, AI module 108 may directly provide PM 114 collected information to customer in customer UI 104 because that may be the only information sought by a customer. In yet another embodiment, AI module 108 may directly provide PostPM 116 collected information to customer in customer UI 104 because that may be the only information sought by sought by a customer. In one more embodiment, AI module 108 may provide the collected information in HRUI 118 including the customized new presentation of data or display of data to customer in customer UI 104 because that may be the only information sought by a customer.

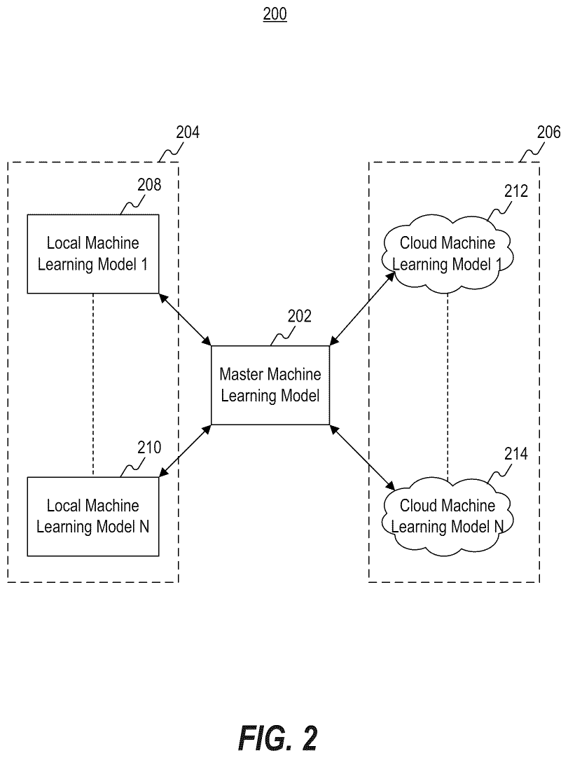

FIG. 2 depicts a schematic block diagram illustrating an exemplary embodiment of the artificial intelligence platform using a plurality of machine learning models and/or algorithms locally and in the cloud, consistent with the disclosed embodiments. For example, each machine learning model and/or algorithm may be designed and/or independently trained for a specific intelligent document processing task. System 200 may include master machine learning model and/or algorithm 202 that may be the central artificial intelligence in IDP 102 or AI module 108. Furthermore, system 200 may include local plurality of machine learning models and/or algorithms 204 and/or cloud-based plurality of machine learning models and/or algorithms 206. The local plurality of machine learning models and/or algorithms 204 may include local machine learning model and/or algorithm 1-208 thru local machine learning model and/or algorithm N-210 in the same server or location as master machine learning model and/or algorithm 202. For example, a business may run system 100 on its local servers that the business maintains. The cloud-based plurality of machine learning models and/or algorithms 206 may include cloud-based machine learning model and/or algorithm 1-212 thru cloud-based machine learning model and/or algorithm N-214 in one or more cloud-based servers or locations separate from master machine learning model and/or algorithm 202. For example, a business may choose to use cloud-based plurality of machine learning models and/or algorithms 206 provided by third-party entities that the business may have purchased from the third-party entities. In another embodiment, the business may install its cloud-based machine learning models and/or algorithms 206 into a third-party cloud server to leverage the addition of extra cloud resources offered by third-party entities where the business may save on computing resources for its local servers. Master machine learning model and/or algorithm 202 may use, leverage, and/or optimize the local plurality of machine learning models and/or algorithms 204 by selecting any of the local machine learning model and/or algorithm 1-208 thru local machine learning model and/or algorithm N-210. Moreover, master machine learning model and/or algorithm 202 may use and/or leverage the cloud-based machine learning models and/or algorithms 206. For example, leveraging may comprise utilizing a pre-trained machine learning model and/or algorithm and further training the model to tune it based on a specific set of input documents and extraction requirements. Similarly, optimizing a machine learning model and/or algorithm may comprise training it to perform a specific task or tuning it to a specific set of input documents. Thus the performance, such as processing speed and accuracy, of a machine learning model and/or algorithm may be improved by narrowing the scope of its functions to performing specific tasks or for processing specific documents. Master machine learning model and/or algorithm 202 may use, leverage, and/or optimize the cloud-based plurality of machine learning models and/or algorithms 206 by selecting any of the cloud-based machine learning model and/or algorithm 1-212 thru cloud-based machine learning model and/or algorithm N 214. Moreover, master machine learning model and/or algorithm 202 may use, select, leverage, and/or optimize the usage of both local plurality of machine learning models and/or algorithms 204 and/or cloud-based plurality of machine learning models and/or algorithms 206.

In one embodiment, master machine learning model and/or algorithm 202 may increase its speed and accuracy by using, selecting, leveraging, and/or optimizing the usage of both the local plurality of machine learning models and/or algorithms 204 and/or cloud-based plurality of machine learning models and/or algorithms 206. The master machine learning model and/or algorithm 202 may learn through comparing, e.g., the collected information, the unstructured data, the semi-unstructured data, the structured data, and the metric report in creating structured data, the plurality of customized new presentation of data or display of data, and the changes requested by human reviewer. By ingesting and analyzing this information, the master machine learning model and/or algorithm 202 may identify patterns to teach itself to better anticipate an output based on one or more requests from customers or users, and to better tune the local and/or cloud-based plurality of machine learning models and/or algorithms 204 and 206, thereby improving speed and accuracy.

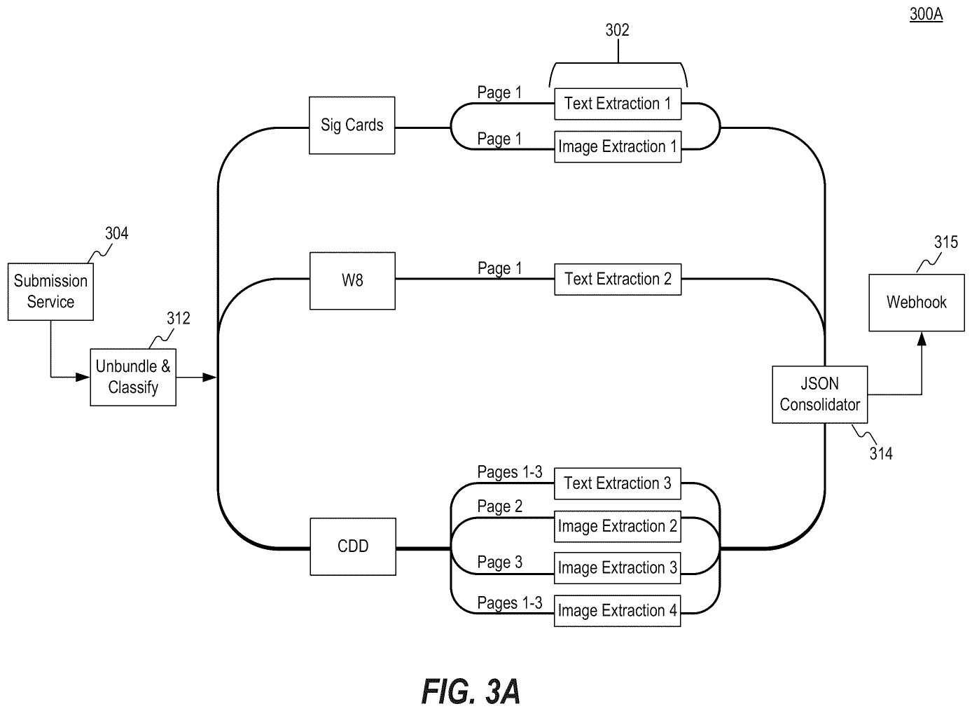

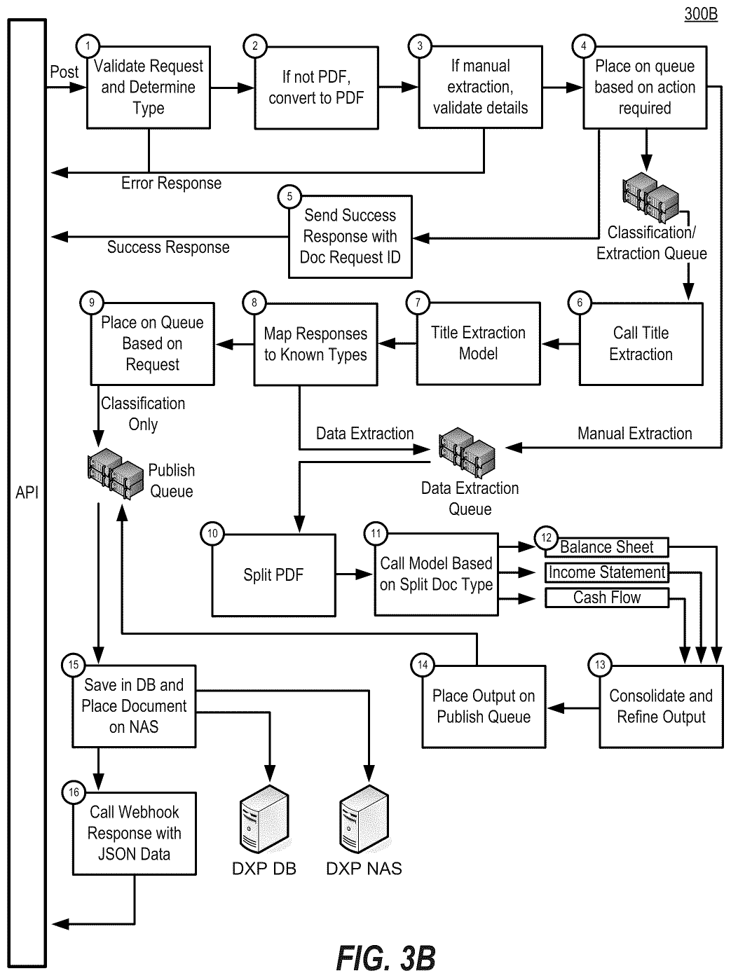

FIG. 3A schematically depicts an exemplary process flow 300A of a plurality of documents from reception through post-processing, consistent with embodiments of the present disclosure. The process flow may be carried out using, e.g., system 100 or IDP 102. In some embodiments, the process flow may comprise a master machine learning model configured to select and direct a plurality of sub-machine learning models (such as system 200 of FIG. 2) and to route the documents through the process flow from one machine learning model to another. Alternatively, in some embodiments, the plurality of documents may be routed to a subsequent machine learning model as selected and/or directed by a prior machine learning model in the process flow. For example, the prior machine learning model may comprise a set of rules or other built-in logic that may be applied to the classification or extraction results of the machine learning model to select a subsequent machine learning model. In some embodiments, the determination of the classification models to which documents are first routed may depend upon the calling application that submits the documents for processing, such as customer UI 104. For example, documents that are submitted by a specific calling application may be routed to specific machine learning models, or the calling application may select a first classification model.

At the start of process flow 300A, a user may submit a plurality of documents via a submission service 304 or other calling application, such as a customer user interface 104 or API module 106 of FIG. 1. In some embodiments, submission service 304 may comprise a document AI platform configured with a catalog of document processing services as further discussed below. Submission service 304 may transmit the plurality of documents to an unbundle/classify module 312. The unbundling and classifying functions of unbundle/classify module 312 may be performed by, e.g., pre-processing module 112 of FIG. 1. In some embodiments, a system 100 may comprise a plurality of unbundle/classify modules 312, and the particular module chosen may be selected by the submission service based on, e.g., the type of documents or the requested operation. Unbundle/classify module 312 may validate a number and type of the plurality of documents and, e.g., identify a file type and format of the plurality of documents. Unbundle/classify module 312 may perform rule-based splitting and document routing to send the plurality of documents to a plurality of further machine learning models 302, where each of the plurality of machine learning models 302 may be designed, trained or otherwise optimized for processing the documents that are routed to it.

In the illustrated example, the plurality of documents may comprise a plurality signature cards, W8 forms and CDD documentation. However, this is for illustrative purposes only. In general, the plurality of documents may comprise any collection of structured, semi-structured and/or unstructured data. As seen in FIG. 3, signature cards and W8 forms may each comprise a single page. The CDD documentation may each comprise, e.g., 3 pages. Unbundle and classify model 312 may split the documents as needed for processing at various machine learning models 302. For example, unbundle and classify module 312 may route page 1 of the signature cards, in whole or in part, to a first text extraction model and may further route page 1 of the signature cards, in whole or in part, to a first image extraction model. The W8 forms may be selected only for text extraction at a second text extraction model, while the CDD documents may be split and routed to a third text extraction model and second through fourth image extraction models as shown.

In general, some embodiments may comprise splitting a document into sub-documents (such as, e.g., individual pages or subcomponents of a document) and routing the sub-documents to different machine learning models, algorithms and/or post-processing steps in order to complete an extraction. For example, a financial statement may be split into sub-documents including a balance sheet section, an income statement section and a statement of cash flow section, etc. Alternatively, documents may be split into one or more text-based sub-documents and one or more image-based sub-documents. Each of these sub-documents may be routed to different machine learning models, algorithms and/or post-processing steps in order to complete the extraction.

Classification may be used first in order to route documents to extraction models based on the type of content on the page or the layout of the content on the page. Classification models may be used to minimize the amount of variance that an extraction model would need to learn from. For example, extraction models typically perform better when their input data is more consistent. For instance, if there is greater consistency in the location on a page at which target information is found across all documents used for training, or if there is more consistency in the set of terms across all documents used for training (e.g. loan specific terms as compared to names as would appear in a death certificate), the model may more quickly and accurately establish relationships mapping inputs to outputs, and thus performance of the model is improved. Once a classification model determines that a document is of a certain type, built-in logic within the platform may dictate the image or text extraction models to which the document or sub-document should be routed as discussed above. After the documents or sub-documents are routed to various processes and machine learning models, their various JSON responses may be formatted and reconstructed into a final JSON string (discussed below) containing the structured data outputs

The first through third text extraction models may be the same or may be different. In some embodiments, the first through third text extraction models may comprise different classes of text extraction models, the same class of text extraction models that have been trained for different tasks, or may comprise identical text extraction models. For example, in some embodiments the first through third text extraction models may be based on the same pre-trained model, with each of the first through third text extraction models being further tuned for a specific task using its own unique set of input documents and extraction requirements. For instance, in some embodiments a pre-trained model from, e.g., Indico or another machine learning platform may be further trained to tune the model to the specific task. For example, if a customer request involves processing its health care patient records, a model may be selected that is pre-trained for, e.g., the general task of processing health care patient records. The model may be provided with further training data based specifically on the format or content of the customer's health care patient records to tune the model to the specific requested task. For example, tuning may comprise teaching a model how to identify or extract certain data, such as a patient identification number, by learning specific information about how the data is contained within the specific patient records that are being processed. Specific information may comprise, e.g. a location of the data within the document, associated object fields, contextual information, or a format of the patient identification number. Likewise, the first through fourth image extraction models may comprise different classes of image extraction models, the same class of image extraction models that have been trained for different tasks, or may comprise identical text extraction models.

After the selected models extract the desired information, the information may be consolidated to a JSON string at JSON consolidator 314 and saved in, e.g., database 110 of FIG. 1. JSON consolidator 314 may be configured to, e.g., place the extracted information into a JSON format. The JSON may be made available via webhook 315. Webhook 315 may comprise a web-based application that enables client applications to fetch a response containing all the extracted information contained in the JSON string. In some embodiments, the JSON string may comprise the structured data that is delivered to a user of IDP 102, such as via customer UI 104, or the JSON string may be used to generate further structured data files. For example, in some embodiments, other systems may fetch information from the JSON string as needed to generate output documents such as word files, excel spreadsheet files, PowerPoint presentation files, pdf files, and/or picture files (png, jpeg, bmp, and/or tiff, gif, or any other related file extensions). In some embodiments, the extracted information may be subjected to post-processing procedures at post-processing module (not shown) prior to consolidation at JSON consolidator 314. The post-processing module may comprise, e.g., PPM 116 of FIG. 1. The post-processing module may perform a number of post-processing operations such as, e.g., scrubbing of model output data, standardization and restructuring, generation of output formats, generation of human review tasks, noise removal, and transmission of output data to further systems and modules.

FIG. 3B schematically depicts an exemplary process flow 300B of a plurality of documents, consistent with embodiments of the present disclosure. The process flow may be carried out using, e.g., system 100 or IDP 102. In some embodiments, the process flow may comprise a master machine learning model configured to select and direct a plurality of sub-machine learning models (such as system 200 of FIG. 2) and to route the documents through the process flow from one machine learning model to another. In some embodiments, the plurality of documents may be routed to a subsequent machine learning model as selected and/or directed by a prior machine learning model in the process flow, such as by applying built-in logic to the classification or extraction results of the machine learning model. In some embodiments, the determination of the classification models to which documents are first routed may depend upon a calling application. For example, documents that are submitted by a specific calling application may be routed to specific machine learning models. The example of FIG. 3B illustrates a portion of a process flow in a financial statement spreading process, depicting a single classification model based on title extraction.

At the start of process flow 300B, a user may submit a plurality of documents via a submission service, such as a customer user interface 104 or API module 106 of FIG. 1. At box 1, a validation process may be performed on the documents. For example, validation may comprise the steps of verifying the information or values in a number of fields such as, e.g., a file type, file name, hash value, login, client application, etc. If any information is inconsistent with an expectation, an error response may be issued to the API as illustrated below box 1. At box 2, the plurality of documents may be converted to a universal document type. For example, it may be determined whether a document is in pdf format, and if not, the document may be converted to pdf format. Next at box 3, it may be determined whether a manual extraction will be performed. A manual extraction may comprise data extraction performed by a human reviewer. If so, details of the manual extraction may be validated, and an error response may be issued to the API if necessary. The document may be passed at box 4 to either a manual data extraction queue or to a classification/extraction queue on a data structure store such as, e.g., REDIS. A success response may be issued with a document request ID to the API at box 5.

At boxes 6 and 7, a title extraction model may be called. The title extraction model may be configured to extract the titles from the plurality of documents. At box 8, the extraction results may be mapped to a set of predetermined known title types to separate the plurality of documents by their classification. For example, at box 9 the plurality of documents may be routed on a classification only path to a publish queue on the data structure store. For example, if a task requires only classification and not data extraction, it may be placed on the classification only path. Alternatively, the plurality of documents may be routed through classification and data extraction at boxes 10-14 prior to being placed on the publish queue.

In the illustrated example, the plurality of documents as pdf files may be split into different document types such as balance sheets, income statements and cash flow statements, each having specific models called with specific extraction tasks. After the splitting and extraction at boxes 10-12, the documents may be consolidated and refined at box 13 using, e.g., the post-processing discussed above. The consolidated and refined output may be, e.g., a JSON string and may be placed on the publish queue at box 14.

By either the classification-only path and the further splitting and extraction path, the plurality of documents may be pulled from the publish queue and saved in, e.g. database and an NAS server. The JSON string comprising extracted information of the plurality of documents may be called via webhook response.

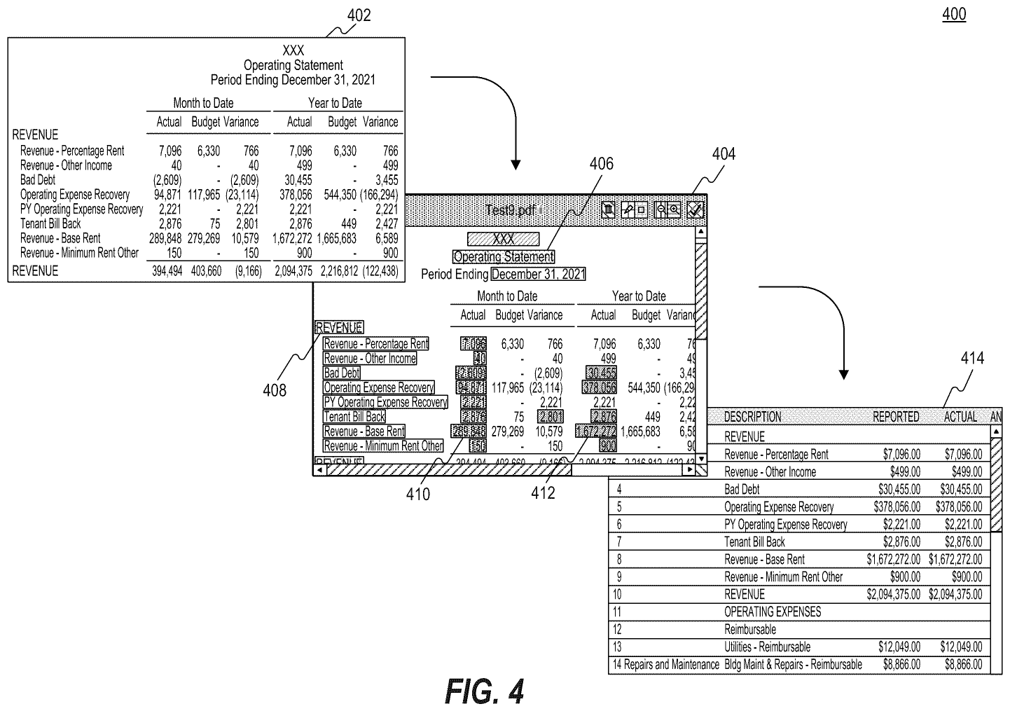

FIG. 4 depicts an exemplary process 400 of extracting and classifying data 404 as input from a document 402 and converting the data 404 into a structured data output 414, consistent with the disclosed embodiments. For example, process 400 may be performed using artificial intelligence system 100 of FIGS. 1A-B. Document 402 may comprise one of a plurality of similar documents that are submitted for processing. For example, document 402 may comprise, e.g., a single operating statement out of a plurality of submitted operating statements and/or other documents. AI module 108 in system 100 may select machine learning models and/or algorithms to process data 404. For example, data 404 may comprise unstructured data, semi-structured data, and/or structured data. Data 404 may comprise various types of data such as, e.g., document title 406, revenue fields 408, month-to-date values 410, and year-to-date values 412. PM 114 may extract and classify the data 406, 408, 410, and 412 into the above categories. AI module 108 may select machine learning models and/or algorithms to construct structured data output 414 in PostPM 116 in system 100.

In some embodiments, structured data output 414 may represent a final output product that is delivered to a user. The output product may comprise, e.g., one or more databases or collections of structured data files as discussed above. The structured data may thus be presented to a user in a format tailored according to the user's needs. In some embodiments, a structured data output may be further refined before it is presented to a user, such as by a human review and/or model retraining process.

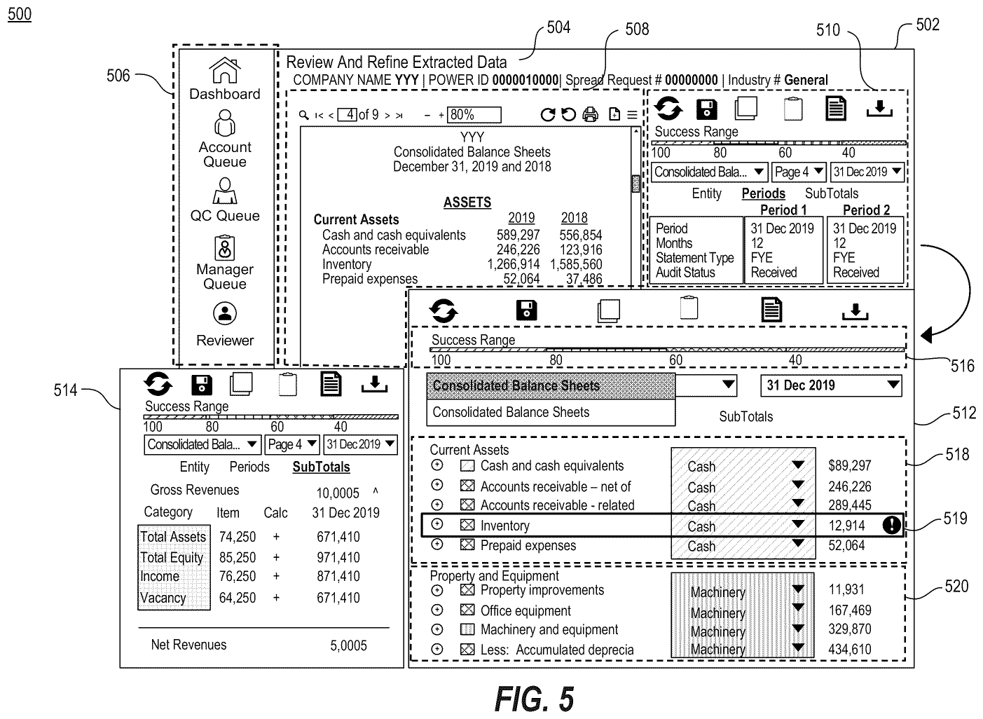

FIG. 5 depicts an exemplary HRUI 500, consistent with the disclosed embodiments. HRUI 500 may comprise, e.g., HRUI 118 of FIG. 1B. HRUI 500 may be configured to enable a human reviewer to manipulate structured data that has been transformed and output from, e.g., Pre-PM 112, PM 114, or Post-PM 116, into a new presentation of data. HRUI 500 may comprise a primary display interface 502 configured to enable navigation among, and display of, a plurality of interactive windows. For example, the primary interface 502 of HRUI 500 may comprise: a task indicator 504; account window 506; input document display 508; output document display 510; output editor 512; table 514; and metric report 516. Task indicator 504 may display information about, e.g., the task being presented to the human reviewer, the client, the industry, or the nature of the displayed documents. Account window 506 may enable a human reviewer to access personalized information such as a dedicated account profile, a queue or docket of pending review tasks assigned to the human reviewer, or a list of document submissions pending for processing by IDP 102 or system 100. Input document display 508 may display original input documents saved by AI module 108 in DB 110 from API module 106 in system 100. Original documents may comprise documents, e.g., in the form that they were originally submitted by a customer, or in an intermediate state prior to being input to one or more processing modules. For example, input document display 508 may display documents as they exist prior to being input for processing at, e.g., API module 106, AI Module 108, Pre-PM 112, PM 114, or Post-PM 116. Conversely, output document display 510 may display transformed data corresponding to the document of input document display 508. For example, output document display may comprise a customized new presentation of data that was extracted from the input document and processed. Input and output document displays 508/510 may allow a human reviewer to make a before-and-after comparison of the data processing operations performed by IDP 102. Output editor 512 may display a further presentation of data corresponding to the data of output document display 510. Output editor 512 may and allow a human reviewer to to edit the further presentation of data, such as by changing the format or the values of the data. For example, the human reviewer may review and edit the arrangement and values of selected data 518, 520. Metric report 516 may display a concise metric report, such as a summary value representing a success metric of the further presentation of data in output editor 512. For example, the metric report may comprise a weighted combination of factors such as, e.g., the accuracy, precision, or confidence level of the performance of one or more machine learning models and/or algorithms used to process the input documents. Furthermore, table 514 may display a more detailed a table reporting individual values such as, e.g., the accuracy, precision, and confidence level.

HRUI 500 may provide a user-friendly interactive display for performing human review tasks. For example, HRUI 500 may be configured to display a flag 519 or other alert to draw a human reviewer's attention to any extracted data that may be assigned a low confidence from the machine learning models. This flagged information may be visually distinguishable from other elements of the display so that human reviewers may quickly identify, review and correct the low-confidence extractions as necessary. A flag may comprise, e.g., an audio alarm, a moving element, a symbol such as a start or exclamation point, or a contrasting color that visually distinguishes the flag from its surrounding imagery. For example, flag 519 may alert a human reviewer to the potential incorrect extraction or new presentation of the 2019 inventory value of 1,266,914 shown in input document display 508, which is displayed in output editor 512 as a value of 12,914. A human reviewer may then correct the value in output editor 512 based on, e.g., a visual assessment of the information in input document display 508. In some embodiments, information that has been extracted with a high confidence level above a predetermined threshold may be routed to bypass the human review process. This may allow reviewers to focus on data that is most likely to be erroneous, which may increase human review throughput and reduce reviewer fatigue.

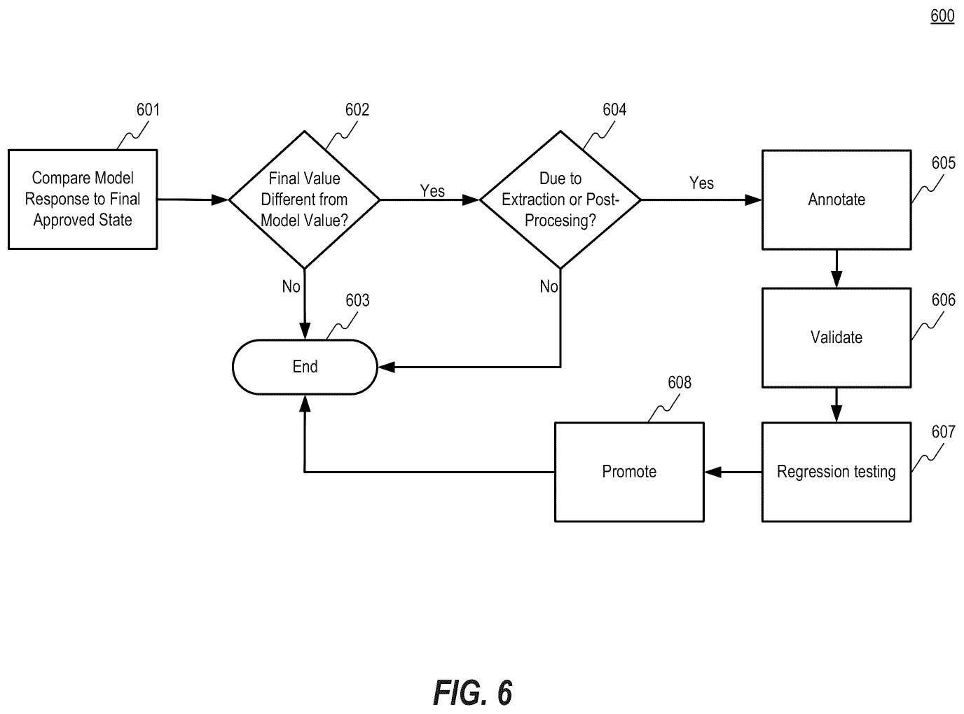

FIG. 6 depicts an exemplary process 600 for model retraining based on corrections from a human review user interface, such as HRUI 118 of FIG. 1. Process 600 may be used to retrain one or more of the plurality of machine learning models and/or algorithms to improve the accuracy and efficiency of, e.g., processing or post-processing such as data extraction, classification etc. For example, retraining may be necessary when a machine learning model and/or algorithm extracts non-targeted data from a document or fails to extract targeted data from the document. Targeted data may comprise, e.g., data that is identified as relevant to the customer's data processing task by, e.g., the customer, an owner or operator of the artificial intelligence system 100, or by one or more of the plurality of machine learning models and/or algorithms. Retraining may be necessary when a machine learning model and/or algorithm or misclassifies or mislabels data. Further, retraining may be necessary when a machine learning model and/or algorithm achieves only a partial extraction of data, such as a partial value. Process 600 may be used for retraining the machine learning models and/or algorithms to avoid such errors. Process 600 may further be used to determine whether a particular human reviewer correction represents feedback that is suitable for retraining the plurality of machine learning models and/or algorithms, or whether it should be disregarded for retraining purposes.

At step 601, a human-reviewed model output such as, e.g., an output of structured data that has been reviewed and/or corrected by a human reviewer using an HRUI according to the discussion above with respect to FIG. 5, may be compared to its corresponding model output without human review. At step 602 it may be determined if there is a difference between the human-reviewed output and the model output, the difference corresponding to a human review correction. If there is no difference, then there may be no feedback or correction to be analyzed. The process may then proceed to step 603 and end for that particular model output. If there is a difference, then the difference may be interpreted as correction by the human reviewer of a mistake by IDP 102. The process may proceed to step 604 where the machine learning models and/or algorithms may discriminate between corrections that are suitable for retraining and those that are not suitable for retraining.

For example, at step 604 the plurality of machine learning models and/or algorithms may determine whether the root cause of the difference from step 602 was due to an action at an extraction model or due to a post-processing model. If the answer is no, the process may proceed to step 603 and end for that particular model output. For example, some pre-processing operations may comprise OCR issues, such as interpreting a numeral 8 as a capital letter “B.” A correction to this discrepancy may be disregarded for retraining purposes because the error did not result from a processing action within, e.g., a processing module or a post-processing module. A further example of a correction that may not be suitable for retraining may be, e.g. a situation in which a value in the model output only appears incorrect because the denomination used to indicate the value has been changed from the model input to the model output. For example, a PDF document that has been submitted for processing may list a data value of, e.g., “$4,000,000.” A chosen denomination in a customized new presentation of the data may be, e.g., millions of dollars instead of dollars. Thus, while 4,000,000 may be supplied as a model output value, a presentation of the data in the new denomination may cause a human reviewer to correct the value to 4. A discrepancy between 4 and 4,000,000 may be disregarded for extraction retraining purposes because the original data extraction of 4,000,000 was correct.

When it is determined that the root cause of a correction does result from an error in an extraction model or a post-processing model, the model retraining process 600 may proceed to the further retraining steps 605-608 of annotation, validation, regression testing, and promotion.

At step 605, a human review annotator may annotate the correction for retraining. The human review annotator may locate the relevant document for the correction, split the document into the relevant sub-documents that include the change, and add the relevant sub-documents to a training set for the machine learning model and/or algorithm to be retrained. Some aspects of the annotation process may be automated and/or may have been performed prior to annotation. For example, a document may already have been split into relevant sub-documents during a pre-processing step. The relevant sub-documents may be stored in a database, such as, DB 110 of FIG. 1. In some embodiments, the database may be explored using, e.g., steps 602 and 604 to identify corrections that represent suitable model development opportunities. For all suitable corrections, the reviewed and unreviewed versions of the relevant sub-documents may be presented to a human review annotator for approval before adding the corrections to the training set.

At step 606, a validation process by, e.g., a data science team may establish that all relevant corrections were introduced for retraining and check an expected change in performance of the machine learning model and/or algorithm against a target scenario. New scenarios may be added to a regression testing battery based on the correction. In some embodiments, a user may be able to monitor the training status of a machine learning model and/or algorithm. In some embodiments, a status table stored in DB 110 may be explored to identify model improvement opportunities. For example, clustering or machine learning techniques may be employed to identify new training data that may require adding new scenarios to the regression testing battery.

In some embodiments, a further plurality of documents may be submitted, such as via HRUI 118 or another interface. The further plurality of documents may comprise test documents, such as “out-of-sample” documents, that may be used to validate model performance. An out-of-sample document may comprise a document that is not contained within a sample population but comprises similar characteristics that are representative of the sample population. For example, the documents may not be the exact same files that were used to train a machine learning model and/or algorithm, but they may be similar so as to capture aspects of the sample set. A test data set may be generated based on the further plurality of documents. Then a second data set may be extracted from the second plurality of documents and classified by, e.g., the same plurality of machine learning models and/or algorithms that were applied to the first data set. The extraction and classification results of the second data set may then be compared to the test data set to validate model performance.

At step 607, regression testing may be performed to monitor for degradation in machine learning model and/or algorithm coverage between a present and updated machine learning model and/or algorithm across the full battery of target scenarios. Software development and IT operations tools, such as the open-source Jenkins platform or another continuous integration/continuous deployment (CDCl) tool, may generate flags or warnings if regression testing is not satisfied. If regression testing is satisfied, then at step 608 the retrained machine learning model and/or algorithm may be promoted to higher environments, and the validation and regression testing processes may be repeated until a machine learning model and/or algorithm is fully retrained.

Model retraining process 600 may advantageously leverage the benefits of human review while maximizing automation and intelligent processing to provide fast turnaround times. Further, the selective use of human review may help to minimize repetitive task fatigue that could introduce errors. Human reviewers may be able to focus on applying their subject matter expertise when reviewing the output data provided from a model inference, incorporating their corrections into the machine learning models and/or algorithms for retraining, allowing the machine learning models and/or algorithms to efficiently, quickly and effectively relearn in targeted scenarios.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1.-37. (canceled)

38. A system comprising:
a database;
a memory storing instructions; and
at least one processor configured to execute the stored instructions to perform operations including:
receiving, from a submission service, a plurality of documents, each of the plurality of documents including a value associated with at least one field chosen from the set of: a file type, a file name, a hash value, a login, and a client application;
validating the value against an expectation value;
converting the plurality of documents to a universal document type based on the validation;
extracting a title from each of the plurality of documents based on the conversion;
classifying the plurality of documents based on the title by mapping the title to a set of predetermined known title types;
consolidating and refining the classified plurality of documents;
placing the consolidated and refined plurality of documents on a publish queue; and
saving the consolidated and refined plurality of documents in a database.

39. The system of claim 38, wherein the universal document type is a portable document format.

40. The system of claim 38, wherein classifying the plurality of documents includes splitting the plurality of documents into one document type chosen from the set of: balance sheets, income statements, and cash flow statements.

41. The system of claim 40, wherein each document type includes a document processing model called with an extraction application programming interface (API) associated with an extraction task.

42. The system of claim 38, wherein the consolidating and refining includes at least one processing operation chosen from the set of: scrubbing the classified plurality of documents, standardizing and restructuring the classified plurality of documents, generating output formats for the classified plurality of documents, generating review tasks associated with the classified plurality of documents, removing noise from the classified plurality of documents, and transmitting the classified plurality of documents.

43. The system of claim 38, wherein the consolidated and refined plurality of documents are a JavaScript Object Notation (JSON) string.

44. The system of claim 43, wherein the operations further include calling the JSON string via a webhook response.

45. The system of claim 38, wherein the operations further include storing the consolidated and refined plurality of documents on a network attached storage (NAS) server.

46. A non-transitory computer-readable medium storing a set of instructions that, when executed by one or more processors of a computing system, cause the computing system to:
receive, from a submission service, a plurality of documents, each of the plurality of documents including a value associated with at least one field chosen from the set of: a file type, a file name, a hash value, a login, and a client application;
validate the value against an expectation value;
convert the plurality of documents to a universal document type based on the validation;
extract a title from each of the plurality of documents based on the conversion;
classify the plurality of documents based on the title by mapping the title to a set of predetermined known title types;
consolidate and refine the classified plurality of documents;
place the consolidated and refined plurality of documents on a publish queue; and
save the consolidated and refined plurality of documents in a database.

47. The non-transitory computer-readable medium of claim 46, wherein the universal document type is a portable document format.

48. The non-transitory computer-readable medium of claim 46, wherein classifying the plurality of documents includes splitting the plurality of documents into one document type chosen from the set of: balance sheets, income statements, and cash flow statements.

49. The non-transitory computer-readable medium of claim 48, wherein each document type includes a document processing model called with an extraction application programming interface (API) associated with an extraction task.

50. The non-transitory computer-readable medium of claim 46, wherein the consolidating and refining includes at least one processing operation chosen from the set of: scrub the classified plurality of documents, standardize and restructure the classified plurality of documents, generate output formats for the classified plurality of documents, generate review tasks associated with the classified plurality of documents, remove noise from the classified plurality of documents, and transmit the classified plurality of documents.

51. The non-transitory computer-readable medium of claim 46, wherein the consolidated and refined plurality of documents are a JavaScript Object Notation (JSON) string.

52. The non-transitory computer-readable medium of claim 51, wherein the instructions further cause the system to call the JSON string via a webhook response.

53. The non-transitory computer-readable medium of claim 46, wherein the instructions further cause the system to store the consolidated and refined plurality of documents on a network attached storage (NAS) server.

54. A method comprising the steps of:
receiving, from a submission service, a plurality of documents, each of the plurality of documents including a value associated with at least one field chosen from the set of: a file type, a file name, a hash value, a login, and a client application;
validating the value against an expectation value;
converting the plurality of documents to a universal document type based on the validation;
extracting a title from each of the plurality of documents based on the conversion;
classifying the plurality of documents based on the title by mapping the title to a set of predetermined known title types;
consolidating and refining the classified plurality of documents;
placing the consolidated and refined plurality of documents on a publish queue; and
saving the consolidated and refined plurality of documents in a database.

55. The method of claim 54, wherein the universal document type is a portable document format.

56. The method of claim 54, wherein classifying the plurality of documents includes splitting the plurality of documents into one document type chosen from the set of: balance sheets, income statements, and cash flow statements.

57. The method of claim 56, wherein each document type includes a document processing model called with an extraction application programming interface (API) associated with an extraction task.

58. The method of claim 54, wherein the consolidating and refining includes at least one processing operation chosen from the set of: scrubbing the classified plurality of documents, standardizing and restructuring the classified plurality of documents, generating output formats for the classified plurality of documents, generating review tasks associated with the classified plurality of documents, removing noise from the classified plurality of documents, and transmitting the classified plurality of documents.

59. The method of claim 54, wherein the consolidated and refined plurality of documents are a JavaScript Object Notation (JSON) string.

60. The method of claim 59, further comprising calling the JSON string via a webhook response.

61. The method of claim 54, further comprising storing the consolidated and refined plurality of documents on a network attached storage (NAS) server.
